(19) United States
(12) Patent Application Publication
(10) Pub. No.: US 2016/0016783 A1
(43) Pub. Date: Jan. 21, 2016

(54) SYSTEMS AND METHODS TO PREDICT FUEL FLOW ISSUES BY MONITORING TRENDS IN THE OPERATION OF FUEL VALVES

(71) Applicant: Gilbarco Inc., Greensboro, NC (US)

(72) Inventors: Ivan Rubin-Ayma, Greensboro, NC (US); Christopher Adam Oldham, High Point, NC (US)

(21) Appl. No.: 14/803,772

(22) Filed: Jul. 20, 2015

Related U.S. Application Data
(60) Provisional application No. 62/026,956, filed on Jul. 21, 2014.

(51) Int. Cl. B67D 7/32; B67D 7/36; B67D 7/04

(52) U.S. Cl. CPC B67D 7/3245; B67D 7/04; B67D 7/36

(57) ABSTRACT

Systems and methods for monitoring fluctuations in the operation of the electromechanical valves of a fuel dispenser over a series of fueling transactions and identifying trends that may indicate mechanical wear of the valve or other fuel system issues. By identifying these issues before fuel dispenser performance is negatively affected, an operator may be notified and preventative maintenance or corrective action may be initiated before the issues affect the customer or gas station throughput.

### PRIORITY CLAIM

This application is based upon and claims priority to provisional application Ser. No. 62/026,956, filed Jul. 21, 2014, incorporated fully herein by reference for all purposes.

### FIELD OF THE INVENTION

Embodiments of the present invention relate generally to fuel dispensers. More specifically, embodiments of the present invention relate to predicting fuel flow issues by monitoring the operation of fuel system components.

### BACKGROUND

In a retail service station environment, the flow rate of fuel dispensed must be controlled for a variety of reasons and requirements. These include but are not limited to prevention of flow, an initial slow flow rate to verify various internal metrological subsystem functionalities, an unrestricted flow rate mode and/or mode limited to a maximum flow rate as specified by jurisdictional regulatory authorities, and a reduced flow rate prior to transaction completion to effect precise cessation at a predetermined volume or price. Furthermore, fuel flow rate at a dispenser is a critical measure of the performance of a fuel delivery system, as it is directly related to gas station throughput.

Historically, variable flow rate has been effectuated by the variation of current within an actuating field coil (hereinafter “valve coil”) of a proportional control valve. By applying current to the valve coil, a mechanical force is produced. This force causes the armature to move the valve into an open position. However, several variables can affect the fuel flow rate, such that the actual flow rate is either above or below the desired flow rate for a given valve current. These variables include problems related to the fuel filter, the fuel valve, meter calibration, and the pumping system. Until the mechanical limits of the valve are reached, the flow rate can be maintained by varying the valve current.

Today, issues with any of the fueling components mentioned above are addressed by regular maintenance, and/or on demand, once actual fuel flow rate at the dispenser fluctuates or does not meet expectations.

### SUMMARY

Example embodiments of the present invention recognize and address considerations of prior art constructions and methods.

According to one aspect, the example embodiments of the present invention provide a fuel dispenser for predicting fuel flow issues, comprising a power source; an electromechanical valve configured to control the flow of fuel from the fuel dispenser; processing circuitry configured to control current delivered to the electromechanical valve; and a current sensor configured to provide feedback to the processing circuitry regarding the current flowing from the power source to the electromechanical valve. The processing circuitry uses feedback from the current sensor to detect and identify trends in the operation of the fuel dispenser.

Another aspect of the present invention provides for an electromechanical valve that is a proportional valve and the current sensor monitors and compares the overall current used to open and close the valve during a transaction. Alternatively, the electromechanical valve may be a two-stage valve and the current sensor monitors and compares the rates of change in flow during the time periods between the On and Off state.

A still further aspect of the present invention provides a method of monitoring trends in the operation of electromechanical fuel valves comprising measuring the current required to operate an electromechanical valve to maintain a given flow rate and storing that amount in system memory. The current required is compared to that required in prior fueling cycles and trends in the operation of the electromechanical valve are identified. If trends in the operation of the electromechanical valve indicate mechanical wear or other valve issues, notification is provided so that preventative action can be taken.

Those skilled in the art will appreciate the scope of the present invention and realize additional aspects thereof after reading the following detailed description of example embodiments in association with the accompanying drawing figures.

### BRIEF DESCRIPTION OF THE DRAWINGS

A full and enabling disclosure of the present invention, including the best mode thereof directed to one of ordinary skill in the art, is set forth in the specification, which makes reference to the appended drawings, in which:

FIG. 1 is a perspective view of an exemplary fuel dispenser which may be constructed in accordance with embodiments of the present invention;

FIG. 2 is a schematic diagram of internal fuel flow components of the fuel dispenser of FIG. 1;

FIG. 3 is a schematic diagram of the control system of an exemplary embodiment of the present invention;

FIG. 4 illustrates a method of monitoring fuel dispenser valve operation and identifying trends in accordance with an embodiment of the present invention;

FIG. 5 shows a schematic diagram of a fuel dispensing environment which may be constructed in accordance with an example embodiment of the present invention; and

FIG. 6 is a schematic communications diagram showing communications between multiple fuel dispensing environments and a centralized diagnostic server.

Repeat use of reference characters in the present specification and drawings is intended to represent same or analogous features or elements of the invention.

### DETAILED DESCRIPTION

Reference will now be made in detail to certain preferred embodiments of the present invention, one or more examples of which are illustrated in the accompanying drawings. Each example is provided by way of explanation of the invention, not limitation of the invention. In fact, it will be apparent to those skilled in the art that modifications and variations can be made in the present invention without departing from the scope or spirit thereof. For instance, features illustrated or described as part of one embodiment may be used on another embodiment to yield a still further embodiment. Thus, it is intended that the present invention covers such modifications and variations.

Some embodiments of the present invention are particularly suitable for use with fuel dispensers in a retail service station environment, and the below discussion will describe example embodiments in that context. However, those of skill in the art will understand that the present invention is not so limited. In fact, it is contemplated that the present invention may be used in other situations where liquid or gas products are delivered. In this regard, “flow rate” is used in the description below as a generic term for the rate of fluid dispensing. In this regard, it will be appreciated that embodiments of the present invention may also be applied to mass/weight rate for mass or weight delivery of weighable products such as, but not limited to, CNG, LNG, and hydrogen. Such delivery is intended herein to be encompassed by the term “flow rate.”

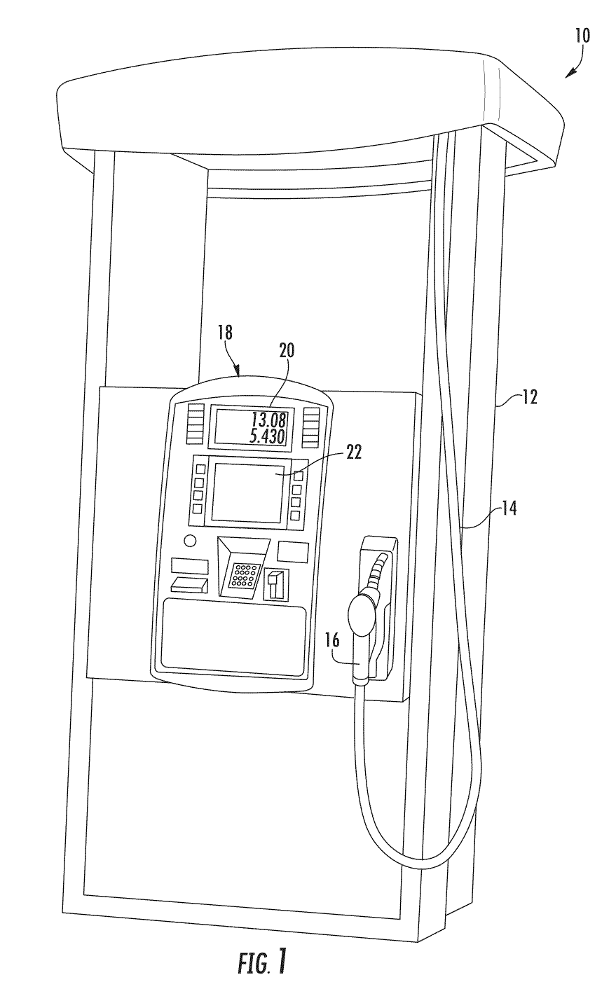

FIG. 1 is a perspective view of an exemplary fuel dispenser 10 in which embodiments of the present invention may be used. For example, fuel dispenser 10 may be the ENCORE® fuel dispenser or the SK700 fuel dispenser, both sold by Gilbarco Veeder-Root. Those of skill in the art will appreciate, however, that the present invention may be used in a variety of fuel dispensers, or other dispensers of liquid or gas products.

Fuel dispenser 10 includes a housing 12 with at least one flexible fuel hose 14 extending therefrom. Fuel hose 14 terminates in a manually-operated nozzle 16 adapted to be inserted into a fill neck of a vehicle's fuel tank. Various fuel handling components located inside of housing 12 allow fuel to be received from underground piping and delivered through hose 14 and nozzle 16 to a vehicle's tank, as is well understood.

The fuel dispenser 10 has a customer interface 18. Customer interface 18 may include a first display 20 that shows the amount of fuel dispensed and the price of the dispensed fuel. Further, customer interface 18 may include a second display 22 to provide instructions for basic transaction functions, such as initiating dispensing of fuel. The dispenser also preferably includes a credit card reader and a PIN pad to allow the customer to pay for the fuel at the dispenser using credit or debit cards.

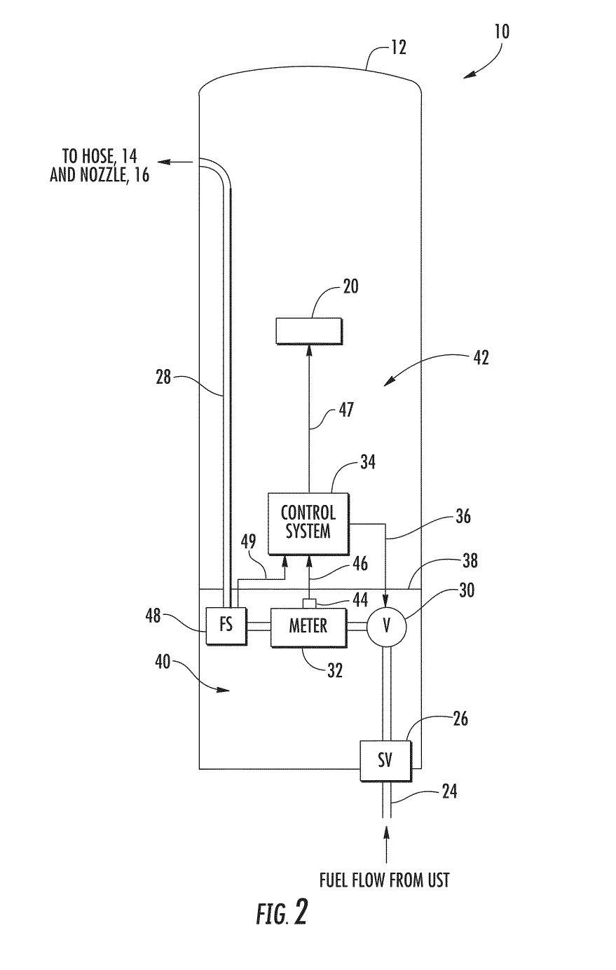

FIG. 2 is a schematic illustration of internal components of fuel dispenser 10. In general, fuel may travel from an underground storage tank (UST) via main fuel piping 24, which may be a double-walled pipe having secondary containment as is well known, to fuel dispenser 10 and nozzle 16 for delivery. An exemplary underground fuel delivery system is illustrated in U.S. Pat. No. 6,435,204 to White et al., hereby incorporated by reference in its entirety for all purposes. In many cases, a submersible turbine pump (STP) associated with the UST is used to pump fuel to the fuel dispenser 10. However, some fuel dispensers may be equipped with a pump and motor within housing 12 to draw fuel from the UST to the fuel dispenser 10.

Main fuel piping 24 may pass into housing 12 first through shear valve 26. As is well known, shear valve 26 is designed to close the fuel flow path in the event of an impact to fuel dispenser 10. U.S. Pat. No. 7,946,309 to Reid et al., hereby incorporated by reference in its entirety for all purposes, discloses an exemplary shear valve adapted for use in service station environments. Shear valve 26 contains an internal fuel flow path to carry fuel from main fuel piping 24 to internal fuel piping 28.

After fuel exits the outlet of the shear valve 26 and enters into the internal fuel piping 28, it may encounter an electromechanical valve 30 positioned upstream of a flow meter 32. (In some fuel dispensers, valve 30 may be positioned downstream of the flow meter 32.) An electromechanical valve uses electric current to control the fuel flow. Although many types of electromechanical valves exist, common fuel dispenser valves include a proportional solenoid controller valve, a diaphragm-based proportional valve, a piston-based proportional valve, and an industry standard two-stage valve (i.e., an On/Off or binary valve). For example, proportional control valve 30 may be a proportional solenoid controlled valve, as described in U.S. Pat. No. 5,954,080 to Leatherman, hereby incorporated by reference in its entirety for all purposes.

As used herein, the term “proportional control valve” denotes any suitable device which includes a coil or other actuator that converts electrical energy into a mechanical force acting upon a fluidic valve to accomplish gradated fuel flow. While operation of a proportional control valve will be described herein, it will be appreciated that aspects of the present invention are applicable to various types of valves, including gas valves, and not all of which are proportional valves. Furthermore, one skilled in the art will appreciate that multiple valves may be used in another embodiment—e.g., in a blended fuel system. Similarly, alternative fuel dispensers may have multiple valves and sensors for controlling pressure not just for delivery but into parts of the dispenser system itself prior to exit for final delivery. Such alternative configurations are within the scope of the invention.

Proportional control valve 30 is under control of a control system 34 via a control valve signal line 36. Control system 34 may comprise a microprocessor, microcontroller, or other suitable electronics with associated memory and software programs running thereon. As described in more detail below, control system 34 controls the application of power from a power source to the valve coil. In this manner, control system 34 can control the degree of opening and closing of the proportional control valve via the valve coil to allow fuel to flow or not flow through meter 32 and on to hose 14 and nozzle 16 at a desired flow rate, or not to flow at all.

Proportional control valve 30 is typically contained below a vapor barrier 38 delimiting a hydraulics compartment 40 of the fuel dispenser 10. Control system 34, on the other hand, is typically located in an electronics compartment 42 of fuel dispenser 10 above vapor barrier 38. The valve coil of control valve 30 may or may not be below the vapor barrier, depending on the construction of the fuel dispenser. In this embodiment, after fuel exits proportional control valve 30, it may flow through meter 32, which measures the volume and/or flow rate of the fuel.

Flow meter 32 may be a positive displacement or inferential flow meter having one or more rotors which rotate on one or more shafts. Some examples of positive displacement flow meter technology which may be used with embodiments of the present invention are provided in U.S. Pat. No. 6,250,151 to Tingleff et al., U.S. Pat. No. 6,397,686 to Taivalkoski et al., and U.S. Pat. No. 5,447,062 to Köpl et al., each of which is hereby incorporated by reference in its entirety for all purposes. Likewise, examples of inferential flow meter technology which may be used with embodiments of the present invention are provided in U.S. Pat. No. 7,111,520 to Payne et al., U.S. Pat. No. 5,689,071 to Ruffner et al., and U.S. Pat. No. 8,096,446 to Carapelli, each of which is also incorporated by reference herein in their entireties for all purposes.

In this embodiment, meter 32 is operatively connected to a displacement sensor 44 that generates a signal indicative of the volumetric flow rate of fuel and periodically transmits the signal to control system 34 via a signal line 46. In this manner, control system 34 can update the total gallons dispensed and the price of the fuel dispensed on display 20 via a communications line 47. In one embodiment, displacement sensor 44 may be a pulser. Those of ordinary skill in the art are familiar with pulsers that may be utilized with embodiments of the present invention. For example, displacement sensor 44 may be the T18350-G6 pulser offered by Gilbarco Inc. Reference is hereby made to U.S. Pat. No. 8,285,506, entitled “Fuel Dispenser Pulser Arrangement,” granted Oct. 9, 2012, the entire disclosure of which is incorporated by reference herein for all purposes. In other embodiments, however, displacement sensor 44 may be another suitable displacement sensor.

In this embodiment, as fuel leaves flow meter 32, it enters a flow switch 48. Flow switch 48, which preferably includes a one-way check valve that prevents back flow through fuel dispenser 10, provides a flow switch communication signal to control system 34 via the flow switch signal line 49. The flow switch communication signal indicates to control system 34 that fuel is actually flowing in the fuel delivery path and that subsequent signals from sensor 44 are due to actual fuel flow.

After the fuel leaves flow switch 48, it exits through internal fuel piping 28 to be delivered through fuel hose 14 and nozzle 16 for delivery to the customer's vehicle. Nozzle 16 typically includes a manually-actuated valve as is well-known in the art.

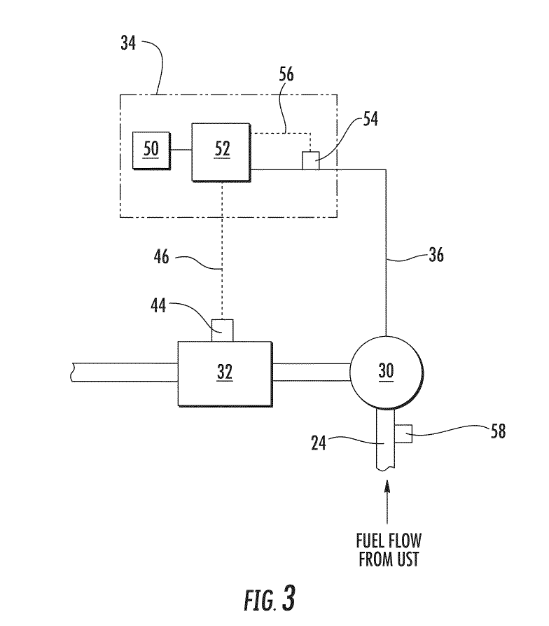

Referring now to FIG. 3, the operation of certain aspects of control system 34 will be described in more detail. As mentioned above, control system 34 controls the application of power from a power source to the valve coil. The valve may be driven, for example, by current, voltage, a pulse-width modulated signal, or other digital signals in various embodiments. In FIG. 3, for example, control system 34 has an internal power source 50 that delivers current to valve 30 via control valve signal line 36 in accordance with instructions from processing circuitry, which may include, for example, PID controller 52 or another suitable controller. For example, the valve could be powered by an external power source that delivers current according to valve current instructions from the control system 34. The valve current instructions may be, for example, current, voltage, a pulse-width modulated signal, or other digital signals in various embodiments.

Preferably, feedback is provided to control system 34 so that the desired coil current may be determined by a PID control algorithm implemented in control system 34. It should be appreciated that control system 34 may include one or more controllers for adjusting the valve coil current in accordance with a variety of control algorithms, of which the PID control algorithm is just one example. In fact, any control algorithm suitable for controlling an electromechanical valve could be substituted and adapted for use in the exemplary embodiment of control system 34.

In this exemplary embodiment, for example, two feedback loops may be used to adjust the valve coil current to achieve the desired fuel flow rate. The first feedback loop adjusts the programmed or “set” coil current to achieve the desired flow rate. The flow rate feedback can be communicated back to the PID controller 52 from a displacement sensor (e.g., pulser) 44 connected to a flow meter 32 via signal line 46. The second feedback loop adjusts and maintains the actual coil current such that it matches the “set” coil current value. The coil current feedback can come from a current detector 54 which can measure the instantaneous values of current flowing through the valve coil and send them to the PID controller 52 as detection signals 56. It will be appreciated that both the flow rate and current feedback will generally be digitized, either by control system 34 or using a separate analog-to-digital converter, for use by control system 34. Alternatively, various suitable analog techniques may also be used (e.g., integrators, comparators, etc.). One skilled in the art will also appreciate that in other embodiments, the current sensor may be omitted and the processing circuitry can use flow rate feedback to achieve the target flow rate.

By monitoring fluctuations in how the valves are operated during multiple fueling transactions in order to accomplish the same flow rate, a trend can be identified where valves progressively require a different current profile to accomplish the same flow rate. This fluctuation and trend may be the result of degradation of the valve itself or another part of the system such as the fuel filters, flow meter, or pumping units. As the fuel dispenser dynamically compensates for those degradations—i.e., by operating the valves to allow more or less flow—there is still no fuel flow rate issue experienced at the dispensing nozzle. This remains true until the valves reach their mechanical limits to compensate, at which point customers may experience actual flow rate issues. Therefore, by looking at trends based upon this data, issues that are building up can be detected before they affect the fuel flow rate out of the dispensers.

In order to implement such trend analysis, the fuel dispenser electronics preferably communicate, for each transaction and for each valve, the current profile required to maintain the desired flow rate. The data that is monitored and the trends that are identified may vary depending on the type of the electromechanical valve being used. For example, with proportional valves, the data to be monitored may be the overall current used during the transaction to open and close the valve. For example, if the overall current required for similar cycles is trending upward, this might indicate an issue with the fuel valve (e.g., mechanical wear), clogging of the fuel filter, or malfunction of the pump. By contrast, if the required current trend is decreasing or erratic, this might indicate a valve problem.

For valves that require static current to attain an open or closed state—e.g., binary valves, two stage valves—the data to be monitored may be the overall time (duration) that the valve was instructed to be On or Off while fueling. By comparing measurements of predictable rates of change in flow at On/Off time periods between valve states (On/Off or Fast/Slow/Off) the hysteresis effects can be examined to predict changes in valve dynamics at run time and can be used to predict changes in static types of valves.

In order to identify a valid trend in the operational variables of the valves as it relates to fuel flow rate, the system might need to compensate for changes in pressure within the fueling system that are part of normal operation. That is, if the same pumping system delivers fuel through multiple dispensers, pressure in the fuel supply lines will vary. The fuel dispensers will react to changes in pressure by desirably varying the valve current. The trend compensation as described herein can still be accomplished by correlating the valve usage data with actual pressure, or by simply correlating with the number of concurrent fueling transactions at the given time within that fueling system.

For example, the fuel dispensing system may include pressure sensing devices placed at suitable locations in the system. For example, a pressure sensor 58 may be placed at the main fuel piping 24. Optionally, further sensors can be added to the system to detect further characteristics of fuel system operation. For example, temperature sensors or probes can be used to measure fuel temperature. Additionally, piezoelectric films or infrared sensors can be used to detect pulsations in the plumbing system in each dispenser or in the underground hydraulics systems of the site.

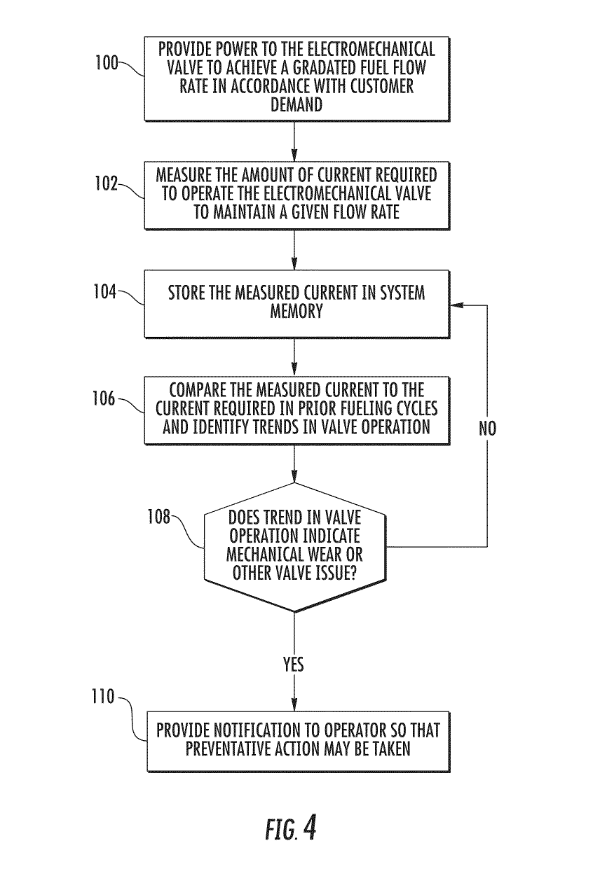

FIG. 4 illustrates a method for detecting fuel flow issues in accordance with an exemplary embodiment of the present invention. The method comprises, at step 100, applying power to a valve coil of a fuel dispenser, wherein the valve coil is configured to accomplish a gradated fuel flow of the fuel dispenser. Current flowing through the valve coil is measured at step 102. At step 104, the measured valve coil current is stored in memory at control system 34 (or some other device in communication with control system 34). At step 106, the measured valve coil current is compared against a predetermined set of conditions that trigger a maintenance alert based on predictions of the future operational status of the fuel dispenser. Based on this comparison, the control system 34 determines whether a maintenance issue exists (step 108) by examining trends in valve operation. If an issue is detected at step 108, the service station operator may be notified (step 110) so that corrective action can be initiated.

In addition to monitoring individual valves, monitored data may be aggregated to identify both local and systemic issues and to isolate these issues for efficient troubleshooting. For example, at the fuel dispenser level, a fuel dispenser can have multiple valves operating concurrently for dispensing one or more fuels through one nozzle. This might occur, for example, when two valves—one delivering 87 octane fuel and another delivering 91 octane fuel—together deliver a proportioned fuel blend that is 89 octane. By aggregating the data from the individual valves, and identifying trends in the operation of those valves (either individually or in aggregate), fuel system issues can be isolated to certain valves or other system components.

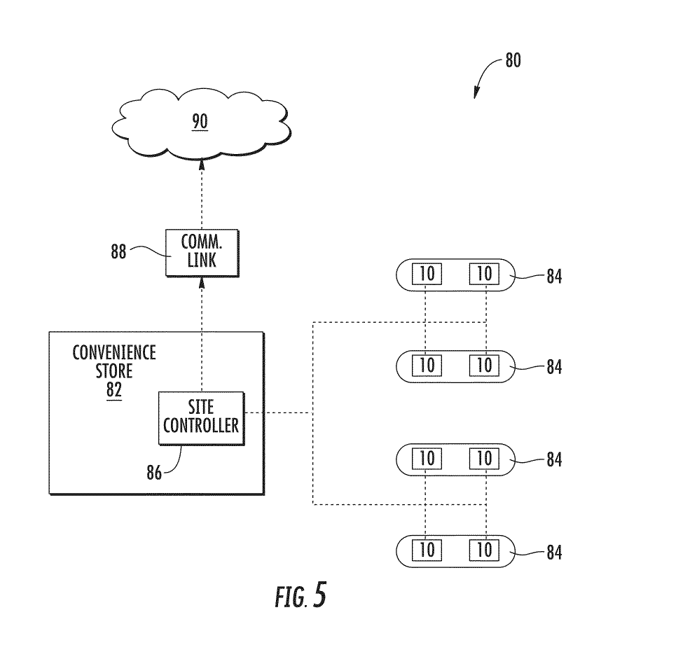

Referring now to FIG. 5, an exemplary fueling environment 80 may comprise a convenience store 82 and a plurality of fueling islands 84. The convenience store 82 may further house a site controller 86, which in an exemplary embodiment may be the PASSPORT® POS system, sold by Gilbarco Inc. of Greensboro, N.C., although third party site controllers may be used. Site controller 86 may control the authorization of fueling transactions and other conventional activities as is well understood. The site controller 86 may preferably be in operative communication with each point of sale terminal (e.g., in the convenience store 82).

Further, site controller 86 may have an off-site communication link 88 allowing communication with a remote host processing system 90 for credit/debit card authorization, content provision, reporting purposes or the like, as needed or desired. In one embodiment, communication link 88 may be a stand alone router, switch, or gateway, although it should be appreciated that site controller 86 may additionally perform the functions of, and therefore replace, such a device. The off-site communication link 88 may be routed through the Public Switched Telephone Network (PSTN), the Internet, both, or the like, as needed or desired. Remote host processing system 90 may comprise at least one server maintained by a third party, such as a financial institution. Although only one remote host processing system 90 is illustrated, those of skill in the art will appreciate that in a retail payment system allowing payment via payment devices issued by multiple payment card companies or financial institutions, site controller 86 may be in communication with a plurality of remote host processing systems 90.

Fueling islands 84 may have one or more fuel dispensers 10 positioned thereon. Fuel dispensers 10 are in electronic communication with site controller 86 through any suitable link, such as two-wire, RS 422, Ethernet, wireless, etc., as needed or desired.

Further information on and examples of fuel dispensers and retail fueling environments are provided in U.S. Pat. Nos. 6,435,204; 5,956,259; 5,734,851; 6,052,629; 5,689,071; 6,935,191; and 7,289,877, all of which are incorporated herein by reference in their entireties for all purposes.

By aggregating data from multiple dispensers connected to the same pumping system, and analyzing trends in valve usage, issues can be isolated to given segments of the fueling environment by looking at different trends for different dispensers.

In addition, aggregating data from multiple gas stations across a region, and analyzing the trends in valve usage correlated to service history, weather, fuel delivery, fuel formulation, etc., can lead to additional insights. For example, this aggregate data may help identify a recent delivery of fuel as being problematic in that it is dirty and thus contaminating the filters, has a problematic fuel formulation, or is otherwise contaminated. By correlating the bad batch of fuel to a specific fuel delivery truck, that truck can be stopped before it delivers fuel to more gas stations.

Another example of insight that might be obtained by observing trends in the aggregated data from multiple gas stations is the identification of a spare part that is shown to wear more rapidly than expected based on service history.

Trends in the replacement or service history of fuel system components can also be used to identify particular service contractors who are not properly servicing the system, or by contrast, those service contractors who are doing a good job. The trends may even be used to identify best practices in fuel system maintenance.

In addition, feedback after a transaction, for example, in the case of leaky valves, can be used to help predict valve mechanical wear characteristics. For example, slow dispensing over a large period of time during dispenser idle states may indicate that a valve is not truly going into an Off position. The small amount of fuel measured after the transactions may indicate a leaky valve that may fail at a later time.

In an exemplary embodiment, the data regarding fuel dispenser operation can be communicated to an on-site system over the existing two-wire infrastructure. This on-site system can aggregate and analyze the data from multiple valves and dispensers. For example, the on-site system can segregate transactions into groups, discriminate transactions that were dispensed at a slow flow rate or at a high flow rate (for dispensers that support multiple flow rates), and identify outliers or trends. The on-site system can further correlate trends in between multiple valves within a dispenser, multiple dispensers within a fueling station, and multiple fueling stations to isolate and identify fuel system issues.

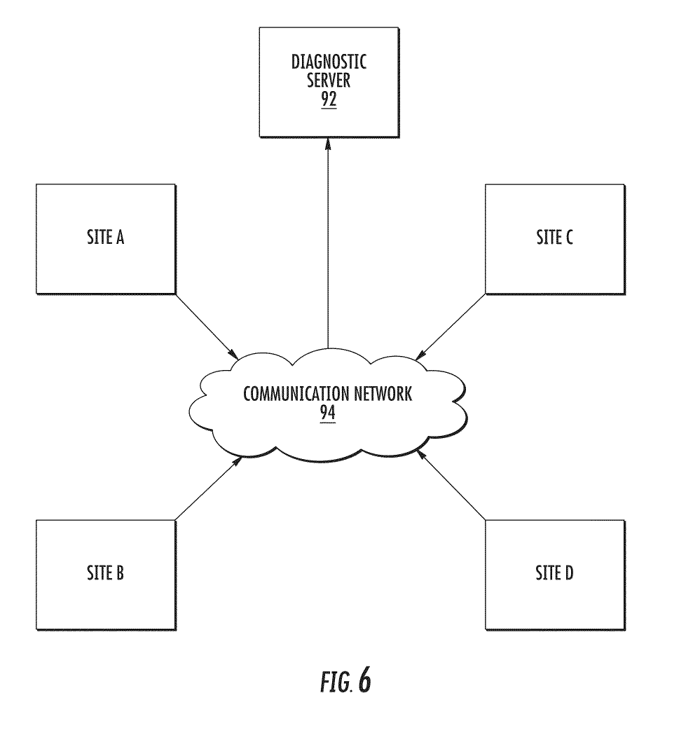

Alternatively, the data may be communicated to a central system that can aggregate data and identify trends in the same manner as an on-site system and even aggregate data from multiple gas stations. For example, as shown in FIG. 6, a diagnostic server 92 may be connected to multiple fueling sites through a communication network 94, for example, through the Internet or the cloud.

While one or more example embodiments of the invention have been described above, it should be understood that any and all equivalent realizations of the present invention are included within the scope and spirit thereof. For example, while the above discussion has focused primarily on current as the measured parameter to indentify trends in operational characteristics, one skilled in the art will appreciate that current is but one instructional parameter that may be used for this purpose. In addition, the embodiments depicted are presented by way of example only and are not intended as limitations upon the present invention. Thus, it should be understood by those of ordinary skill in this art that the present invention is not limited to these embodiments since modifications can be made. Therefore, it is contemplated that any and all such embodiments are included in the present invention as may fall within the scope and spirit thereof.

1. A fuel dispenser for predicting fuel flow issues, comprising:
a power source;
an electromechanical valve configured to control the flow of fuel from the fuel dispenser;
processing circuitry configured to control current delivered to the electromechanical valve; and
a current sensor configured to provide feedback to the processing circuitry regarding current flowing from the power source to the electromechanical valve,
wherein the processing circuitry uses feedback from the current sensor to detect and identify trends in the operation of the fuel dispenser.

2. The fuel dispenser of claim 1, wherein the electromechanical valve is a proportional valve and the current sensor monitors and compares current used to open and close the valve during a transaction.

3. The fuel dispenser of claim 1, wherein the electromechanical valve is a two-stage valve and the current sensor monitors and compares the rates of change in flow during the time periods between the On and Off state.

4. The fuel dispenser of claim 1, wherein the processing circuitry compensates for change in pressure by correlating the amount of current delivered to the electromechanical valve with the actual system pressure during dispensing.

5. The fuel dispenser of claim 1, wherein the processing circuitry aggregates the data from multiple individual valves that may be operating concurrently during fuel dispensing in order to identify and isolate valve issues.

6. The fuel dispenser of claim 1, wherein the processing circuitry aggregates the data from multiple fuel dispensers connected to the same pumping system in order to identify and isolate trends related to fuel dispenser operation.

7. The fuel dispenser of claim 1, wherein the processing circuitry aggregates the data from multiple gas stations across a region and analyzes trends in that data.

8. A method of monitoring trends in the operation of electromechanical fuel valves comprising:
measuring current required to operate an electromechanical valve to maintain a given flow rate;
storing the current required in system memory;
comparing the current required to that required in prior fueling cycles and identifying trends in the operation of the electromechanical valve; and
providing notification if trends in the operation of the electromechanical valve indicate mechanical wear or other valve issues so that preventative action can be taken.

9. A fuel dispenser for predicting fuel flow issues, comprising:
a power source;
an electromechanical valve configured to control flow or pressure into specific parts of the fuel dispenser;
processing circuitry configured to control current, voltage, pulse width modulation or digital signals delivered to the electromechanical valve; and
a fuel flow meter that provides feedback to the processing circuitry regarding fuel flow in order for the processing circuitry to operate the valve to reach a fuel flow target,
wherein the processing circuitry uses the current, voltage, pulse width modulation or digital signals delivered to the electromechanical valve to detect and identify trends in the operation of the fuel dispenser.

10. The fuel dispenser of claim 9, wherein the electromechanical valve is a proportional valve and the processing circuitry monitors and compares the current, voltage, pulse width modulation or digital signals required to operate it.

11. The fuel dispenser of claim 9, wherein the electromechanical valve is a one-stage or two-stage valve and the processing circuitry monitors and compares the time periods between the On and Off states.

12. The fuel dispenser of claim 9, wherein the processing circuitry compensates for change in pressure by correlating the amount of current, voltage, pulse width modulation or digital signals delivered to the electromechanical valve with the actual system pressure during dispensing.

13. The fuel dispenser of claim 9, wherein the processing circuitry aggregates the data from multiple individual valves that may be operating concurrently during fuel dispensing in order to identify and isolate valve issues.

14. The fuel dispenser of claim 9, wherein the processing circuitry aggregates the data from multiple fuel dispensers connected to the same pumping system in order to identify and isolate trends related to fuel dispenser operation.

15. The fuel dispenser of claim 9, wherein the processing circuitry aggregates the data from multiple gas stations across a region and analyzes trends in that data.
